(19) United States
(12) Patent Application Publication
(10) Pub. No.: US 2026/0368967 A1
(43) Pub. Date: Nov. 19, 2026

(54) Object-Preserving Text-to-Image Synthesis

(71) Applicant: Google LLC, Mountain View, CA (US)

(72) Inventors: Xuhui Jia, Seattle, WA (US); Yang Zhao, Redmond, WA (US); Cheuk Kit Kelvin Chan, Redmond, WA (US); Yandong Li, Orlando, FL (US); Han Zhang, Sunnyvale, CA (US); Boqing Gong, Bellevue, WA (US); Tingbo Hou, Santa Clara, CA (US); Huisheng Wang, Los Altos Hills, CA (US); Yu-Chuan Su, Bellevue, WA (US)

(21) Appl. No.: 19/470,736

(22) PCT Filed: Mar. 28, 2024
(86) PCT No.: PCT/US2024/021958

§ 371 Date: Sep. 29, 2025

Related U.S. Application Data
(60) Provisional application No. 63/492,663, filed on Mar. 28, 2023.

(51) Int. Cl. G06T 11/60; G06T 7/11

(52) U.S. Cl. CPC G06T 11/60; G06T 7/11; G06T 2207/20081

(57) ABSTRACT

Provided are systems and methods for generating images of objects specified by users or otherwise provided as an input. Provided is a general framework that bypasses the lengthy optimization required by previous approaches, which often employ a per-object optimization paradigm. Instead, the proposed framework adopts an encoder to capture high-level identifiable semantics of objects, producing an object-specific embedding with only a single feed-forward pass. The acquired object embedding is then passed to a text-to-image synthesis model for subsequent generation.

### PRIORITY CLAIM

The present application is based on and claims priority to U.S. Provisional Application 63/492,663 having a filing date of Mar. 28, 2023. U.S. Provisional Application 63/492,663 is hereby incorporated by reference herein in its entirety.

### FIELD

The present disclosure relates generally to machine learning. More particularly, the present disclosure relates to systems and methods for performing object-preserving text-to-image synthesis.

### BACKGROUND

Text-to-image synthesis has gained increasing attention and experienced rapid development with recent advances of generative adversarial networks (GANs), diffusion models, and other forms of generative models. With sophisticated designs and enormous amount of training data, images with unprecedented quality and diversity can be generated through conditioning on free-form texts provided by users.

Apart from generic objects, one field of research is to enable models to synthesize images capturing an object specified by users. Generating a particular object requires the understanding of its high-level concept, which is intricate, if not impossible, when the desired object is not contained in the training set. To remedy the domain gap, certain existing methods generally adopt a fine-tuning paradigm, where a text prompt representing the object and a pre-trained synthesis model are jointly optimized using multiple images of the object provided by users. The optimized text prompt is then combined with natural language descriptions to generate outputs containing the object with various content and styles.

However, in practice, training a model for each object is infeasible to scale up for practical uses. In particular, as object-specific fine-tuning is required, the aforementioned paradigm is unable to produce fast adaptation to arbitrary objects. The applicability of such methods is further limited by the intractable model storage cost, which increases with the number of objects considered. Furthermore, these methods usually require multiple images of the same object, which is not always available in reality.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform object-preserving text-to-image synthesis. The method includes obtaining, by a computing system comprising one or more computing devices, an input image that depicts an object and a text prompt that specifies desired content of an output image. The method includes processing, by the computing system, the input image with a machine-learned image encoder model to generate an object embedding for the object. The method includes processing, by the computing system, the text prompt with a machine-learned text encoder model to generate a text embedding for the text prompt. The method includes processing, by the computing system, the object embedding and the text embedding with a machine-learned generative model to generate a synthetic image, wherein the synthetic image depicts the object in combination with the desired content. The method includes providing, by the computing system, the synthetic image as the output image.

Another example aspect of the present disclosure is directed to a computer system for training at least a machine-learned generative model to perform object-preserving text-to-image synthesis. The computer system includes one or more processors and one or more non-transitory computer-readable media that collectively store instructions that, when executed by the one or more processors, cause the computer system to perform operations. The operations include obtaining a training input image that depicts an object. The operations include processing the training input image with one or more machine-learned caption generation models to generate a caption for the training input image. The operations include processing the training input image with an image encoder model to generate an object embedding for the object. The operations include processing the caption with a text-encoder model to generate a text embedding for the caption. The operations include processing the object embedding and the text embedding with a generative model to generate a synthetic image. The operations include evaluating a reconstruction loss function that generate a loss value based on the synthetic image and the training input image. The operations include modifying one or more parameter values of at least the generative model based on the reconstruction loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example inference scheme for performing object-preserving text-to-image synthesis according to example embodiments of the present disclosure.

FIG. 2A depicts a block diagram of an example training scheme for performing object-preserving text-to-image synthesis according to example embodiments of the present disclosure.

FIG. 2B depicts a block diagram of an example cross-reference regularization training scheme for performing object-preserving text-to-image synthesis according to example embodiments of the present disclosure.

FIG. 2C depicts a block diagram of an example object-embedding-dropping training scheme for performing object-preserving text-to-image synthesis according to example embodiments of the present disclosure.

FIG. 3A depicts a block diagram of an example computing system that performs text-to-image synthesis according to example embodiments of the present disclosure.

FIG. 3B depicts a block diagram of an example computing device that performs text-to-image synthesis according to example embodiments of the present disclosure.

FIG. 3C depicts a block diagram of an example computing device that performs text-to-image synthesis according to example embodiments of the present disclosure.

Reference numerals that are repeated across plural figures are intended to identify the same features in various implementations.

### DETAILED DESCRIPTION

### Overview

Generally, the present disclosure is directed to systems and methods for generating images of objects specified by users or otherwise provided as an input. Example implementations described herein are based on a general framework that bypasses the lengthy optimization required by previous approaches, which often employ a per-object optimization paradigm. Instead, the proposed framework adopts an encoder to capture high-level identifiable semantics of objects, producing an object-specific embedding with only a single feed-forward pass. The acquired object embedding is then passed to a text-to-image synthesis model for subsequent generation. To effectively blend an object-aware embedding space into a well-developed text-to-image model under the same generation context, the present disclosure provides different network designs and training strategies and proposes a simple yet effective regularized joint training scheme with an object identity preservation loss. Additionally, the present disclosure provides a caption generation scheme that can assist in ensuring that the object-specific embedding is faithfully reflected in the image generation process, all while keeping control and editing abilities. Once trained, the proposed models are able to produce diverse content and styles, conditioned on both texts and objects. The proposed techniques are able to synthesize images with compelling output quality, appearance diversity, and object fidelity, without the need of test-time optimization.

More particularly, in contrast to certain existing approaches which perform object-specific fine-tuning of generative models, aspects of the present disclosure are directed to a single general model that is able to compose a new scene around given objects yet without the need of per-object optimization, using as few as one image. This is an unexplored direction in spite of its wide applicability. Specifically, the present disclosure introduces a general framework as the first step towards this goal. Unlike existing works that discretely align a target object with a unique prompt through iterative optimization, example implementations continuously project object embedding and text-to-image generation embedding into an unified semantic space.

Despite being straightforward, several non-trivial questions remain, including how to adapt text-to-image models to the object embeddings and how to construct training data for improving personalization while preserving editing capability in the pre-trained models. As one example, given the object embedding as an extra input, some example implementations insert additional attention modules to a text-to-image network. The augmented network can then be fine-tuned to condition also on the object embedding. However, directly fine-tuning the network with the object embedding can result in deteriorated editing capability. Therefore some example implementations perform a regularized joint training scheme with an object-preservation loss to maintain editability while making the model object-conditioning.

In addition, another example aspect of the present disclosure introduces a caption generation scheme for augmenting the training dataset. This essentially increases data specificity, leading to performance gain in terms of output quality, appearance diversity, and object fidelity.

The present disclosure provides a number of technical effects and benefits. In particular, with personalized text-to-image synthesis becoming an indispensable task in content creation, an efficient algorithm is of utmost importance to improve its applicability. The present disclosure provides solutions towards this direction and demonstrate how the optimization process can be bypassed without sacrificing performance. The resultant model possesses simplicity and produces a personalized image in a single feed-forward pass, leading to reduced computational and storage costs.

More particularly, certain prior approaches to object-preserving image synthesis require fine-tuning a generative model on a per-object basis. This results in the need to perform additional fine-tuning operations for each object. These additional fine-tuning operations require consumption of computational resources such as processor cycles, memory usage, network bandwidth, etc. Similarly, existing approaches which require fine-tuning a generative model on a per-object basis will also result in one model for each object. As the number of objects grows, storing one model per object consumes a significant amount of computer memory.

The techniques described herein obviate the need to perform fine-tuning on a per-object basis. Instead, one general model can be trained and then applied to previously unseen objects in a single forward pass. By obviating the need to perform fine-tuning on a per-object basis, the techniques described herein can significantly conserve computational resources such as processor cycles, memory usage, network bandwidth, etc. Therefore, the present disclosure represents an improvement to a computer system itself.

With reference now to the Figures, example embodiments of the present disclosure will be discussed in further detail.

### Example Inference Scheme

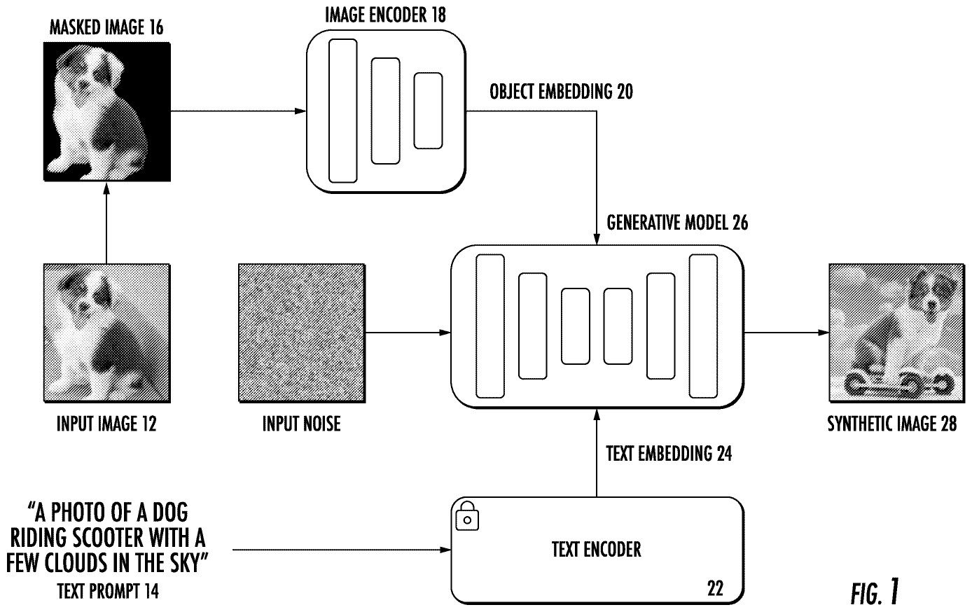

As shown in FIG. 1, an example framework includes a number of components. One component is a text encoder 22. For example, the text encoder can be a pre-trained model to enable text-conditioning synthesis. Another component is an image encoder 18. The image encoder 18 can be used to encode arbitrary objects into object embeddings 20, which serve as a second condition for a generative model 26 for object-specific generation. To accommodate object embeddings 20 which are not part of the pre-trained model, some example implementations can augment the network by inserting cross-attention modules.

Specifically, let x be an image containing the object of interest and c be text caption describing a desired output image. The image object encoder [symbol] and text encoder [symbol] can be used to compute the object embedding [symbol] (x) and text embedding [symbol] (c), respectively. The embeddings are then passed to the generative model 26 (e.g., which can be an augmented text-to-image diffusion model, to generate the final output synthetic image 28. In general, the illustrated framework is flexible and is not confined to a particular architecture. Example model architectures for the generative model 26 include Imagen and Stable Diffusion.

The object encoder [symbol] is responsible for capturing the concept of an object and is an important component of the framework. In theory, one can use networks of any forms as the encoder, but significant performance differences may be noticed with different choices of networks. In some implementations, in order to capture complex concepts, the image encoder can be trained with 1) large amount of data and 2) an objective relating concrete objects with abstract descriptions. Therefore, some example implementations can adopt a frozen pretrained CLIP image encoder. However, the framework can alternatively include a more sophisticated encoder for potential performance gain. In some implementations, the text encoder [symbol] is a frozen T5-XXL as in Imagen.

More particularly, FIG. 1 depicts a block diagram of an example inference scheme for performing object-preserving text-to-image synthesis according to example embodiments of the present disclosure. As illustrated in FIG. 1, a computing system can obtain an input image 12 that depicts an object. The computing system can also obtain a text prompt 14 that specifies desired content of an output image. For example, in FIG. 1, the input image 12 depicts a particular dog and the text prompt 14 requests “A photo of a dog riding scooter with a few clouds in the sky”.

The computing system can process the input image 14 with a machine-learned image encoder model 18 to generate an object embedding 20 for the object. In some implementations, the input image 14 can be directly provided as input to machine-learned image encoder model 18. In other implementations, the object can be extracted from the input image 12. For example, segmentation can be performed on the input image 12 to identify a portion of the input image 12 that depicts the object. The computing system can extract the portion of the input image 12 that depicts the object. For example, a mask can be applied to the input image to generate a masked image 16. The masked image 16 can be provided as input to the image encoder 18 to generate the object embedding 20.

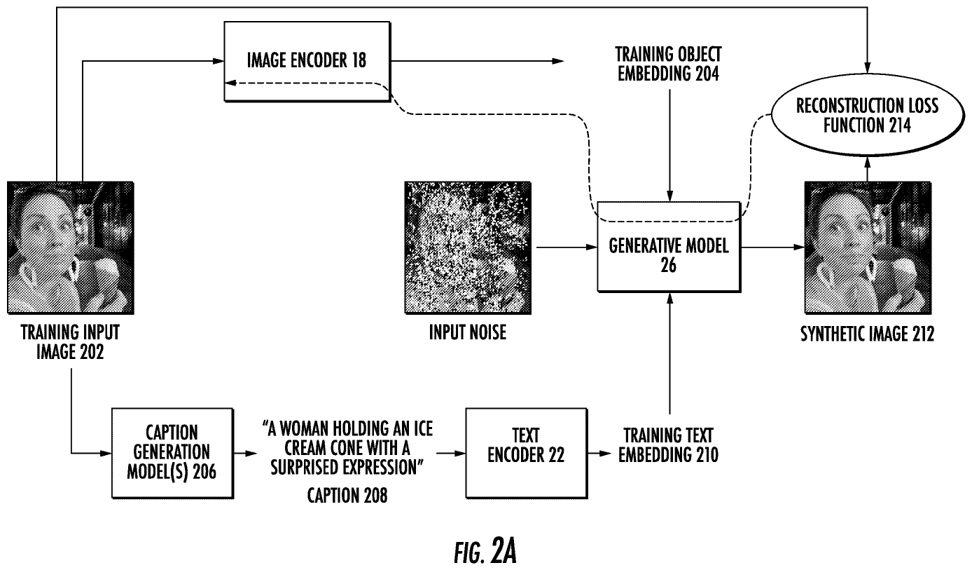

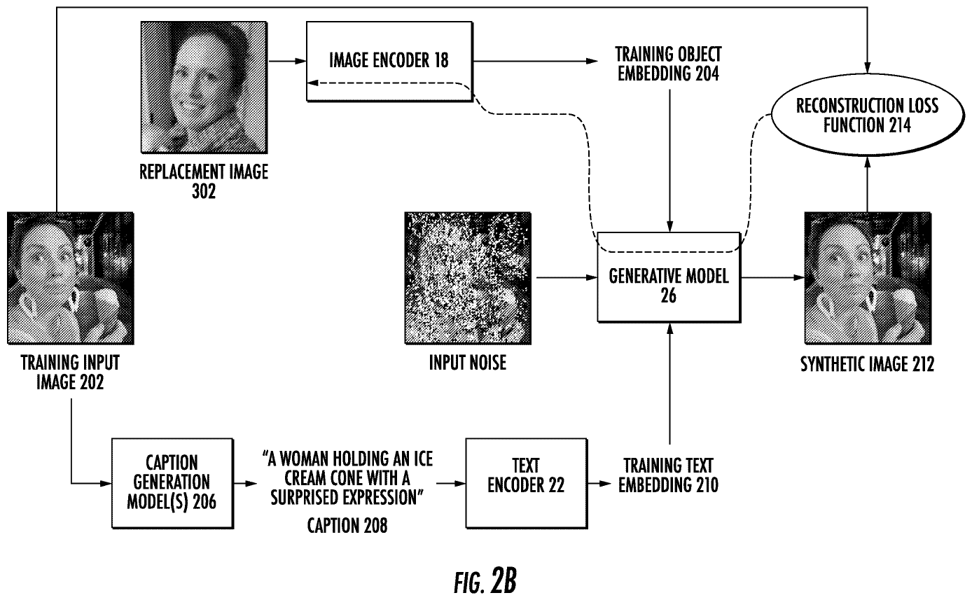

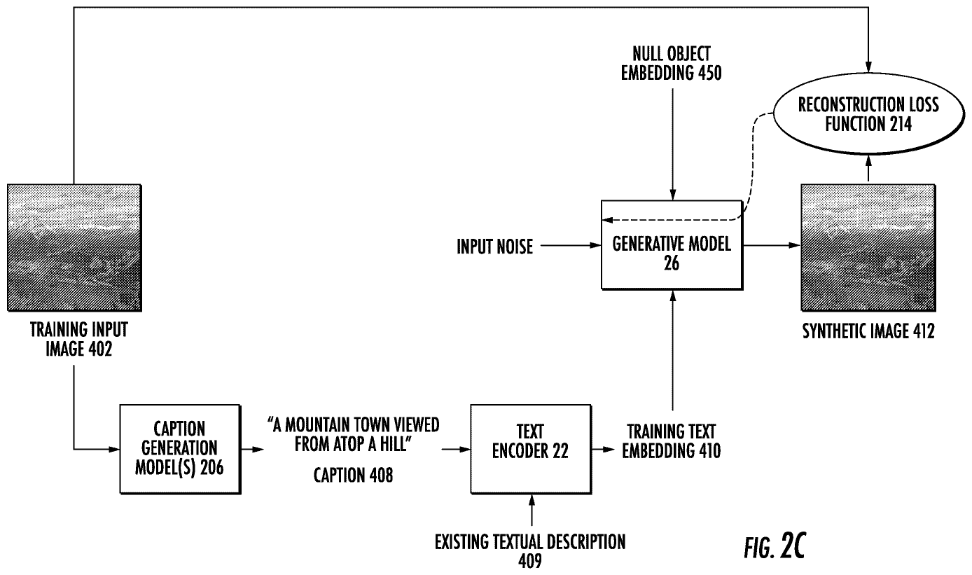

The computing system can also process the text prompt 14 with a machine-learned text encoder model 22 to generate a text embedding 24 for the text prompt 14. In some implementations, one or both of the image encoder 18 and the text encoder 22 can be pre-trained models. In some implementations, one or both of the image encoder 18 and the text encoder 22 can be further fine-tuned after pre-training, for example, as described with reference to FIGS. 2A-C.

Referring still to FIG. 1, the computing system can process the object embedding 20 and the text embedding 24 with a machine-learned generative model 26 to generate a synthetic image 28. In some implementations, the machine-learned generative model 26 can be a pre-trained model, such as, for example, the Imagen model. In some implementations, the machine-learned generative model 26 can be fine-tuned after pre-training, for example, as described with reference to FIGS. 2A-C.

Referring still to FIG. 1, the synthetic image 28 can depict the object in combination with the desired content. For example, in the illustrated example of FIG. 1, the synthetic image 28 depicts the specific, particular dog from the input image 12 in combination with the content described in the text prompt 14 (e.g., the particular dog is riding a scooter with a few clouds in the sky). The computing system can provide the synthetic image as an output image.

In some implementations, instead of directly synthesizing images at the target resolution of 1024×1024, the generative model 26 can adopt a cascaded structure. For example, in some implementations, the model 26 first generates an 64×64 image and then uses two text-conditioning super-resolution models to upsample the image to 256×256 and then to 1024×1024.

Furthermore, unlike most existing works that perform iterative optimization for each object, some example frameworks only require a single forward pass to generate images of an object. This essentially reduces the computation and storage overhead incurred by per-object optimization.

### Example Training Schemes

As one example. FIG. 2A depicts a block diagram of an example training scheme for performing object-preserving text-to-image synthesis according to example embodiments of the present disclosure. As illustrated in FIG. 2A, a computing system can obtain a training input image 202 that depicts an object. For example, the example training input image 202 depicts a woman holding an ice cream cone.

In some implementations, the training input image 202 is an in-domain training image. An image may be “in-domain” if it depicts content (e.g., an object) that belongs to one or more classes for which the group of models will ultimately be used to generate synthetic images. Conversely, an image may be “out-of-domain” if it does not depict content (e.g., an object) that belongs to the one or more classes for which the group of models will ultimately be used to generate synthetic images. In other implementations, a model can be trained to handle all classes of objects.

The computing system can process the training input image 202 with one or more machine-learned caption generation models 206 to generate a caption 208 for the training input image 202. For example, in FIG. 28, the caption generation model 206 has generated a caption 208 that reads: “A woman holding an ice cream cone with a surprised expression”.

In some implementations, the caption generation model 206 can be a language-image model such as, for example, the PaLI model. Additionally or alternatively, the caption generation model 206 can be an attribute classification network.

As an example, let f_{c} be a caption generation model 206. The model 206 can be applied to an input image x to obtain the coarse caption c_{c}=f_{c}(x). In addition to the general description provided by this model 206 (e.g., the PaLI model), some example, implementations can further incorporate concrete attributes (e.g., face attributes) if they are available. Let fₐ be the attribute classification network, an example fine caption c_{f}=fₐ(x) can be generated by applying fₐ to the image. The two captions can then be concatenated as the final caption c. This example approach generates captions with both abstract and concrete description, circumventing the loss of text-conditioning property.

Referring still to FIG. 2A, the computing system can process the training input image 202 with an image encoder model 18 to generate a training object embedding 204 for the object detected in the training input image 202. As a general matter, improved object specificity can be obtained when the object embedding 204 depends only on the object, and is agnostic to the background. Therefore, in some implementations, to better disentangle the object from the input image, a binary mask can initially be applied to remove the background. For example, let fₘ be the mask generation function, we have o=fₒ(x⊗m), where ⊗ denotes pointwise multiplication, and m=fₘ(x) denotes the binary mask. In such a way, the object embedding 204 depends only on the object, possessing higher object specificity. This approach can be applied during training and/or during inference.

In some implementations, the combination of the training input image 202, the caption 208, and the training object embedding 204 can be referred to as a training triplet. The computing system can process the caption 208 with a text-encoder model 22 to generate a text embedding 210 for the caption 208. The computing system can process the object embedding 204 and the text embedding 210 with a generative model 26 to generate a synthetic image 212.

The computing system can evaluate a reconstruction loss function 214 that generates a loss value based on the synthetic image 212 and the training input image 202. The computing system can then modify one or more parameter values of at least the generative model 26 based on the reconstruction loss function 214. For example, the reconstruction loss function 214 can be backpropagated through the generative model 26. In some implementations, only the generative model 26 is trained. In other implementations, the computing system can also modify one or more parameter values of the image encoder model 18 based on the reconstruction loss function 214. For example, the reconstruction loss function 214 can continue to be backpropagated through the image encoder 18. Backpropagation is represented in FIG. 2A using a dashed line.

In some implementations, the generative models described herein can be denoising diffusion models. For example, conditioned on text embeddings c, an example denoising diffusion model can be trained with the following example denoising objective

$${𝔼}_{x , c , ε , t} [ {‖ {ε}_{θ} ( {x}_{t} , t , c ) - ε ‖}_{2}^{2} ] \qquad ( 1 )$$

where xₜ is a noisy version of the groundtruth image, ε~ [symbol] (0, I) denotes standard Gaussian, and t is the timestep.

In some implementations, classifier-free guidance can be used to improve diffusion model sample quality. It efficiently trains one model for both conditional and unconditional objectives, achieved by randomly dropping the condition c. During sampling, the intermediate predictions are adjusted based on the conditional and unconditional outputs as:

\hat{ε}₀(xₜ,c)=wε₆(xₜ,c)+(1−w)ε_{θ}(xₜ,c_{Ø}), (2)

where w is the guidance weight and c_{Ø} is the embedding of an empty text string. The guidance effect increases with w.

Another aspect of the present disclosure is directed to a regularized joint training approach. In particular, overfitting a pretrained model with only few images sometimes can lead to a potential danger that the model forget precious skills gained during pretraining. However the proposed framework can target a large collection of objects from similar categories, which makes joint training with conventional text-to-image data possible. Moreover, personalization can be improved through training on large-scale text-image dataset and domain-specific dataset jointly.

However, directly mixing the two datasets results in the loss of text-conditioning capability with the object embedding dominating the generation. Therefore, it is a challenging task to effectively condition the network on the extra object embedding without compromising the text-to-image synthesis capability. To overcome these challenges the present disclosure proposes a regularized joint training scheme to 1) avoid dominance of the object embedding and 2) enhance object fidelity.

One example aspect of the regularized joint training scheme can include performing cross-reference regularization. In particular, motivated by the fact that the object embedding is shared across images of the same object, some example implementations can perform cross-reference regularization to encourage disentanglement of identity information from the object embedding. For example, given an additional image x̅ capturing the same object, some example implementations can randomly replace the object embedding ō by that computed from x̅:

$$z = ( \begin{matrix}( x , \overline{o} , t ) & if p < ω , \\ ( x , o , t ) & otherwise ,\end{matrix} \qquad ( 3 )$$

where p~Uni(0,1) and ω is a pre-determined threshold.

Here z represents the training triplet. Note that in some implementations the regularization is applied only for domain-specific images. Then, the generative model learns to distill object-specific information from the object embedding, essentially removing image-specific clues. This can significantly improve the object fidelity.

As one example, FIG. 2B depicts a block diagram of an example cross-reference regularization training scheme for performing object-preserving text-to-image synthesis according to example embodiments of the present disclosure. In some implementations, a computing system can perform either FIG. 2A or FIG. 2B with some randomness (e.g., depending on whether a value sampled from a uniform distribution is less than a specified threshold).

Referring to FIG. 2B, a computing system can obtain a training input image 202 that depicts an object. The computing system can process the training input image 202 with the one or more machine-learned caption generation models 206 to generate a caption 208 for the training input image 202. The computing system can process the caption 208 with the text-encoder model 22 to generate a text embedding 210 for the caption 208.

As shown in FIG. 2B, the computing system can process, with an image encoder model 18, a replacement training input image 302 to generate a replacement object embedding for the object. The replacement training input image 302 can depict the same object as the training input image 202. For example, as shown in FIG. 2B, the replacement input image 302 depicts the same woman as the training input image 202. However, in the replacement input image 302 the woman is shown from a different angle and has a different facial expression.

The computing system can process the replacement object embedding 204 and the text embedding 210 with a generative model 26 to generate a synthetic image 212. The computing system can evaluate a reconstruction loss function 214 that generates a loss value based on the synthetic image 212 and the training input image 202.

The computing system can modify one or more parameter values of at least the generative model 26 based on the reconstruction loss function 214. For example, the reconstruction loss function 214 can be backpropagated through the generative model 26. In some implementations, only the generative model 26 is trained. In other implementations, the computing system can also modify one or more parameter values of the image encoder model 18 based on the reconstruction loss function 214. For example, the reconstruction loss function 214 can continue to be backpropagated through the image encoder 18. Backpropagation is represented in FIG. 2A using a dashed line.

One example aspect of the regularized joint training scheme can include performing object-embedding dropping. In particular, in practice, one could apply the object encoder to the images in the general-domain dataset. However, in some cases this results in the generation process being dominated by the object embedding. As a result, the trained network generates outputs solely based on the object embedding, neglecting the text conditions.

To overcome this issue, some example implementations can impose an implicit regularization to reduce the reliance on the object embedding, especially for general-domain images. For example, let z be the triplet during training, in some implementations, the object embedding is set to a null embedding for general domain images:

$$z = ( \begin{matrix}( x , o , t ) & if x is domain - specific , \\ ( x , ϕ , t ) & otherwise ,\end{matrix} \qquad ( 4 )$$

where φ denotes a fixed null embedding. In this case, the network learns to leverage object embedding for domain-specific objects, while keeping the capability of text-conditioning through reconstructing general-domain images solely with text embedding.

As one example, FIG. 2C depicts a block diagram of an example object-embedding-dropping training scheme for performing object-preserving text-to-image synthesis according to example embodiments of the present disclosure. As shown in FIG. 2C, a computing system can obtain a training input image 402. In some implementations, the training input image 402 is an out-of-distribution image.

The computing system can process the training input image 402 with the one or more machine-learned caption generation models 206 to generate a caption 408 for the training input image 402. Alternatively or additionally, the computing system may obtain an existing textual description 409 for the training input image 402.

The computing system can process the caption 408 and/or the existing textual description 409 with the text-encoder model 22 to generate a text embedding 410. The computing system can also process a null object embedding 450 and the text embedding 410 with a generative model 26 to generate a synthetic image 412.

The computing system can evaluate a reconstruction loss function 214 that generates a loss value based on the synthetic image 412 and the training input image 402. The computing system can modify one or more parameter values of at least the generative model 26 based on the reconstruction loss function 214. For example, the reconstruction loss function 214 can be backpropagated through the generative model 26.

In some implementations, the whole network can be trained or finetuned. In other implementations, only some subset or portions of the network (e.g., only the attention layer(s)) are trained or finetuned.

### Example Devices and Systems

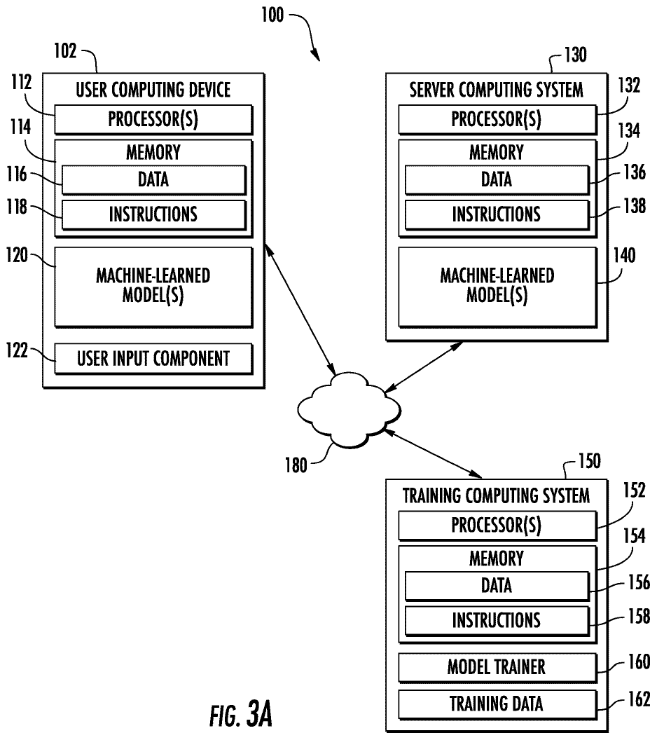

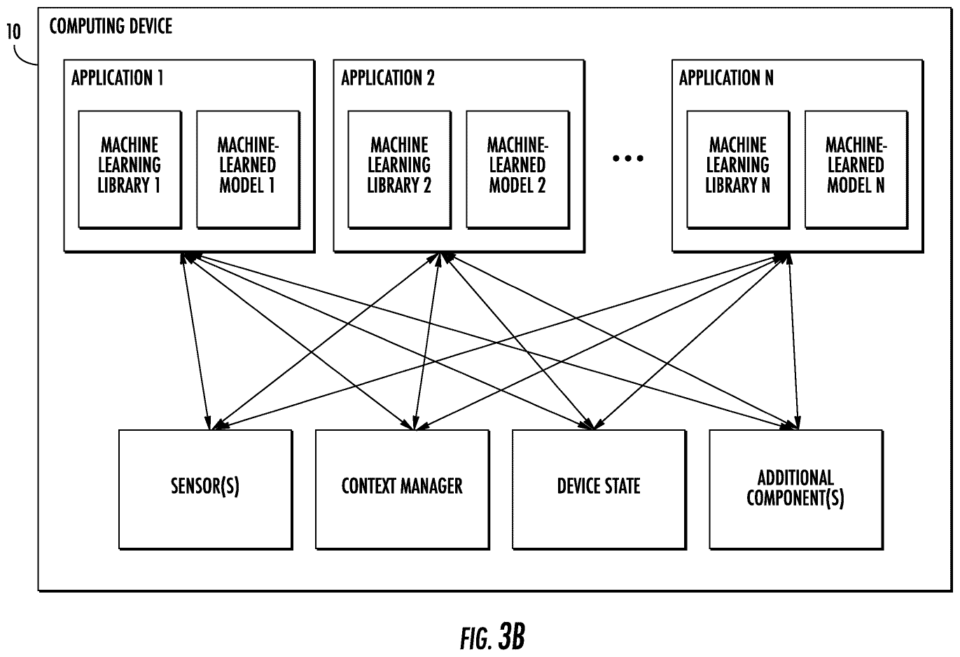

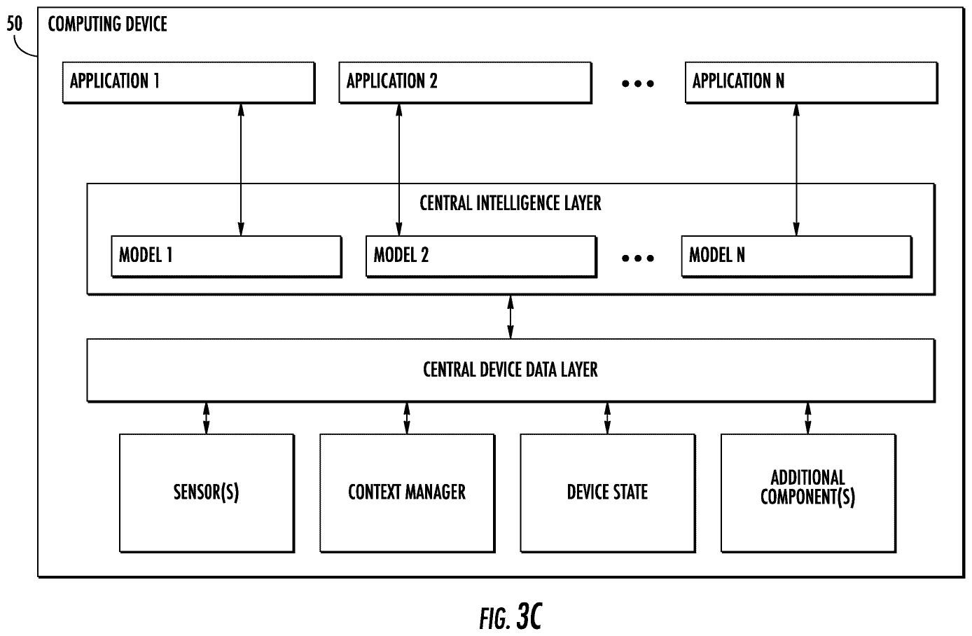

FIG. 3A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-2C.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image synthesis across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image synthesis service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-2C.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, triplets as described or shown in any of FIGS. 2A-C.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform object-preserving text-to-image synthesis, the method comprising:
obtaining, by a computing system comprising one or more computing devices, an input image that depicts an object and a text prompt that specifies desired content of an output image;
processing, by the computing system, the input image with a machine-learned image encoder model to generate an object embedding for the object;
processing, by the computing system, the text prompt with a machine-learned text encoder model to generate a text embedding for the text prompt;
processing, by the computing system, the object embedding and the text embedding with a machine-learned generative model to generate a synthetic image, wherein the synthetic image depicts the object in combination with the desired content; and
providing, by the computing system, the synthetic image as the output image.

2. The computer-implemented method of claim 1, wherein processing, by the computing system, the input image with the machine-learned image encoder model to generate an object embedding for the object comprises:
performing, by the computing system, segmentation on the input image to identify a portion of the input image that depicts the object;
extracting, by the computing system, the portion of the input image; and
processing, by the computing system, the extracted portion of input image with the machine-learned image encoder model to generate an object embedding for the object.

3. The computer-implemented method of claim 1, wherein the machine-learned image encoder model comprises a pre-trained image encoder.

4. The computer-implemented method of claim 1, wherein:
at least the machine-learned generative model has been trained on a plurality of training triplets; and
at least one of the plurality of training triplets comprises:
a training input image;
a training object embedding generated for the training input image by the machine-learned image encoder model; and
a training text embedding generated by the machine-learned text encoder model for a caption associated with the training input image.

5. The computer-implemented method of claim 4, wherein the training input image comprises an in-domain image for a certain object class.

6. The computer-implemented method of claim 5, wherein the input image comprises an in-domain image for the certain object class.

7. The computer-implemented method of claim 4, wherein the caption associated with the training input image was generated for the training input image using one or more machine-learned caption generation models.

8. The computer-implemented method of claim 4, wherein the machine-learned image encoder model and the machine-learned generative model have been jointly trained using the plurality of training triplets.

9. The computer-implemented method of claim 4, wherein at least the machine-learned generative model has been trained using a reconstruction loss that generates a loss value based on the training input image and a training output image generated by the machine-learned generative model as a result of processing the training object embedding and the training text embedding.

10. The computer-implemented method of claim 1, wherein at least the machine-learned generative model has been trained using a cross-reference regularization scheme in which, for one or more training examples, a training object embedding generated for a training input image is replaced with a replacement object embedding generated from a replacement input image that depicts a same training object.

11. The computer-implemented method of claim 1, wherein at least the machine-learned generative model has been trained using an object-embedding-dropping scheme in which, for one or more training examples, a training object embedding generated for a training input image is replaced with a null object embedding.

12. The computer-implemented method of claim 1, wherein the machine-learned generative model has not been fine-tuned on the input image.

13. A computer system for training at least a machine-learned generative model to perform object-preserving text-to-image synthesis, the computer system comprising:
one or more processors; and
one or more non-transitory computer-readable media that collectively store instructions that, when executed by the one or more processors, cause the computer system to perform operations, the operations comprising, for one or more first training iterations:
obtaining a training input image that depicts an object;
processing the training input image with one or more machine-learned caption generation models to generate a caption for the training input image;
processing the training input image with an image encoder model to generate an object embedding for the object;
processing the caption with a text-encoder model to generate a text embedding for the caption;
processing the object embedding and the text embedding with a generative model to generate a synthetic image;
evaluating a reconstruction loss function that generate a loss value based on the synthetic image and the training input image; and
modifying one or more parameter values of at least the generative model based on the reconstruction loss function.

14. The computer system of claim 13, wherein the operations further comprises, for each of the one or more first training iterations: modifying one or more parameter values of the image encoder model based on the reconstruction loss function.

15. The computer system of claim 13, wherein the training input image comprises an in-domain training image.

16. The computer system of claim 13, wherein the operations further comprise, for each of one or more second training iterations:
obtaining a second training input image that depicts a second object;
processing the second training input image with the one or more machine-learned caption generation models to generate a second caption for the second training input image;
processing the second caption with the text-encoder model to generate a second text embedding for the second caption;
processing, with an image encoder model, a replacement training input image that also depicts the second object to generate a replacement object embedding for the second object;
processing the replacement object embedding and the second text embedding with a generative model to generate a second synthetic image;
evaluating the reconstruction loss function that generates the loss value based on the second synthetic image and the second training input image; and
modifying one or more parameter values of at least the generative model based on the reconstruction loss function.

17. The computer system of claim 13, wherein the operations further comprise, for each of one or more third training iterations:
obtaining a third training input image, wherein the third training input image comprises an out-of-distribution image;
processing the third training input image with the one or more machine-learned caption generation models to generate a third caption for the third training input image;
processing the third caption with the text-encoder model to generate a third text embedding for the third caption;
processing a null object embedding and the third text embedding with a generative model to generate a third synthetic image;
evaluating the reconstruction loss function that generates the loss value based on the third synthetic image and the third training input image; and
modifying one or more parameter values of at least the generative model based on the reconstruction loss function.

18. The computer system of claim 13, wherein the operations further comprise modifying one or more parameter values of the image encoder model based on the reconstruction loss function.

19. One or more non-transitory computer-readable media that collectively store an image encoder model and a generative model that have previously been trained via the performance of training operations, the training operations comprising:
obtaining a training input image that depicts an object;
processing the training input image with one or more machine-learned caption generation models to generate a caption for the training input image;
processing the training input image with the image encoder model to generate an object embedding for the object;
processing the caption with a text-encoder model to generate a text embedding for the caption;
processing the object embedding and the text embedding with the generative model to generate a synthetic image;
evaluating a reconstruction loss function that generate a loss value based on the synthetic image and the training input image; and
modifying one or more parameter values of at least the generative model based on the reconstruction loss function.

20. The one or more non-transitory computer-readable media of claim 19, wherein one or more cross-attention modules are defined between the image encoder model and the generative model.
